(19) United States
(12) Patent Application Publication
(10) Pub. No.: US 2015/0275086 A1
(43) Pub. Date: Oct. 1, 2015

(54) NEMATIC LIQUID CRYSTAL COMPOSITION AND LIQUID CRYSTAL DISPLAY DEVICE USING SAME

(71) Applicant: DIC CORPORATION, Tokyo (JP)

(72) Inventors: Takeshi Kuriyama, Kita-adachi-gun (JP); Joji Kawamura, Kita-adachi-gun (JP)

(73) Assignee: DIC CORPORATION, Tokyo (JP)

(21) Appl. No.: 14/437,114

(22) PCT Filed: Oct. 21, 2013
(86) PCT No.: PCT/JP2013/078438

§ 371 Date: Apr. 20, 2015

(30) Foreign Application Priority Data
Oct. 24, 2012 (JP) 2012-234706

(51) Int. Cl. C09K 19/30; C09K 19/54

(52) U.S. Cl. CPC C09K 19/3066; C09K 19/3003; C09K 19/542; C09K 2019/3004; C09K 2019/301; C09K 2019/3021; C09K 2019/3016; C09K 2019/3019; C09K 2019/548

(57) ABSTRACT

There is provided a nematic liquid crystal composition which has a positive dielectric anisotropy (Δ∈) and is useful as a liquid crystal display material, and to a liquid crystal display device using it. The liquid crystal composition has a dielectric anisotropy with a high absolute value and low viscosity. The liquid crystal display device using the liquid crystal composition has high contrast, high-speed response, and high display quality, and thus image sticking and display defects are not caused. The liquid crystal display device that uses the liquid crystal composition is a useful liquid crystal display device in which high-speed response is achieved and generation of display defects is reduced. The liquid crystal display device is particularly useful as an active matrix driving liquid crystal display device and can be applied to liquid crystal display devices with an IPS mode, a TN mode, or the like.

### TECHNICAL FIELD

The present invention relates to a nematic liquid crystal composition which has a positive dielectric anisotropy (Δ∈) and is useful as a liquid crystal display material, and to a liquid crystal display device using the nematic liquid crystal composition.

### BACKGROUND ART

Liquid crystal display devices have been used for clocks, calculators, measuring instruments, panels for automobiles, word processors, electronic organizers, printers, computers, televisions, clocks, advertising signage, etc. Typical examples of a liquid crystal display mode include a TN (twisted nematic) mode, an STN (super twisted nematic) mode, a vertical alignment mode that uses a TFT (thin film transistor), and an IPS (in-plane switching) mode. Liquid crystal compositions used for such liquid crystal display devices need to be stable against external factors such as moisture, air, heat, and light, exhibit a liquid crystal phase in as wide as possible temperature range centered around room temperature, and have a low viscosity and a low drive voltage. Furthermore, such a liquid crystal composition contains several compounds to several tens of compounds for the purpose of achieving, for example, an optimum dielectric anisotropy (Δ∈) and/or an optimum refractive index anisotropy (Δn) in accordance with individual display devices.

In vertical alignment displays, a liquid crystal composition whose Δ∈ is negative is used. In horizontal alignment displays with a TN mode, an STN mode, or an IPS mode, a liquid crystal composition whose Δ∈ is positive is used. A driving method has been reported in which a liquid crystal composition whose Δ∈ is positive is vertically aligned when no voltage is applied and display is achieved by applying a horizontal electric field. Thus, such a liquid crystal composition whose Δ∈ is positive has been increasingly required. Furthermore, low-voltage driving, high-speed response, and a wide operation temperature range have been required in any driving method. That is, positive Δ∈ with a high absolute value, low viscosity (η), and a high nematic phase-isotropic liquid phase transition temperature (Tₙᵢ) have been required. Furthermore, to control Δn×d, which is a product of Δn and cell gap (d), Δn of the liquid crystal composition needs to be adjusted in an appropriate range in accordance with the cell gap. In addition, since an importance is given to high-speed response when liquid crystal display devices are applied to televisions or the like, a liquid crystal composition having low γ₁ is demanded.

A liquid crystal composition has been disclosed that uses, as a component of the liquid crystal composition, a liquid crystal compound whose Δ∈ is positive and which is represented by formula (A-1) or (A-2) (PTL 1 to PTL 4).

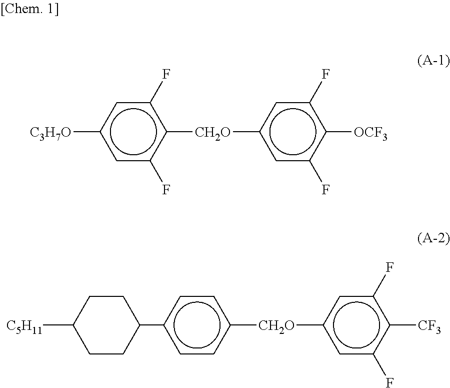

When the liquid crystal composition is practically used for liquid crystal display devices, the display quality needs to be not degraded. In particular, a liquid crystal composition used for active matrix driving liquid crystal display devices that are driven with a TFT element or the like needs to have high resistivity or high voltage holding ratio. Such a liquid crystal composition also needs to be stable against outer factors such as light and heat. In view of the foregoing, an antioxidant for improving the stability against heat and a liquid crystal composition that uses such an antioxidant have been disclosed (refer to PTL 3 and PTL 4), but they do not show always sufficient properties. In particular, a liquid crystal compound with high Δ∈ has relatively poor stability against light and heat, and thus the quality stability of such a composition is not sufficient.

With the increasing number of applications of liquid crystal display devices, methods of using the liquid crystal display devices and methods of producing the liquid crystal display devices have also been markedly changed. In order to catch up with these changes, it has been desired to optimize properties other than known basic physical properties. Specifically, regarding liquid crystal display devices that use a liquid crystal composition, VA (vertical alignment) mode liquid crystal display devices, IPS (in-plane switching) mode liquid crystal display devices, and the like have been widely used, and very large display devices having a 50-inch or larger display size have been practically used. Regarding a method for injecting a liquid crystal composition into a substrate, with the increase in the substrate size, a one-drop-fill (ODF) method has been mainly used instead of an existing vacuum injection method. However, it has been found that drop marks formed when a liquid crystal composition is dropped onto a substrate result in a problem of a decrease in the display quality. Furthermore, a PS (polymer stabilized) liquid crystal display device has been developed in order to generate a pre-tilt angle of a liquid crystal material in a liquid crystal display device and achieve high-speed response. Such a display device is characterized by adding a monomer to a liquid crystal composition and curing the monomer in the composition. In many cases, the monomer is cured by irradiating the composition with ultraviolet rays. Therefore, when a component having poor stability against light is added, the resistivity or the voltage holding ratio is decreased and, in some cases, drop marks are also formed, resulting in a decrease in the yield of liquid crystal display devices due to display defects.

As described above, the development of liquid crystal display devices which have high stability against light, heat, and the like and in which display defects such as image sticking and drop marks are not easily caused has been demanded while the properties and performance required for liquid crystal display devices, such as high-speed response, are maintained.

### CITATION LIST

### Patent Literature

PTL 1: WO96/032365

PTL 2: Japanese Unexamined Patent Application Publication No. 09-157202

PTL 3: WO98/023564

PTL 4: Japanese Unexamined Patent Application Publication No. 2003-183656

PTL 5: Japanese Unexamined Patent Application Publication No. 9-124529

PTL 6: Japanese Unexamined Patent Application Publication No. 2006-169472

### SUMMARY OF INVENTION

### Technical Problem

It is an object of the present invention to provide a liquid crystal composition which has positive Δ∈, has a liquid crystal phase over a wide temperature range, has a low viscosity, has high solubility at low temperature, has a high resistivity and a high voltage holding ratio, and is stable against heat and light, and also a liquid crystal display device with an IPS mode, a TN mode, or the like in which high display quality is achieved and the generation of display defects such as image sticking and drop marks is reduced by using the liquid crystal composition.

### Solution to Problem

The present inventors have studied various liquid crystal compounds and various chemical substances and have found that the above object can be achieved by combining particular compounds. Thus, the present invention has been completed.

There is provided a nematic liquid crystal composition that contains, as a first component, one or more compounds selected from the group consisting of compounds represented by general formula (I-1) to general formula (I-3),

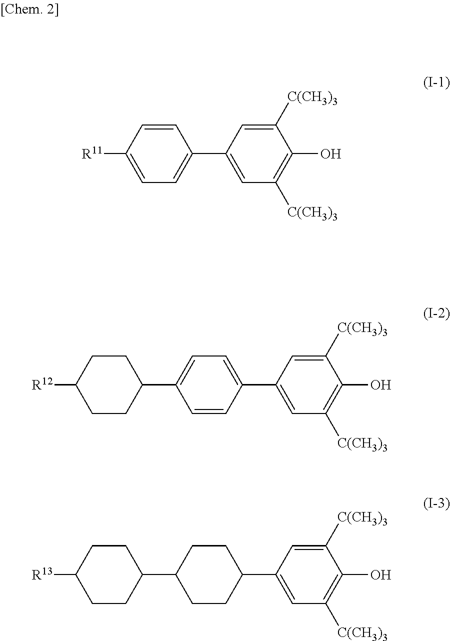

(in the formulae, R¹¹ to R¹³ represent an alkyl group or alkoxy group having 1 to 22 carbon atoms) and that contains, as a second component, one or more compounds selected from the group consisting of compounds represented by general formula (II-a) to general formula (II-e),

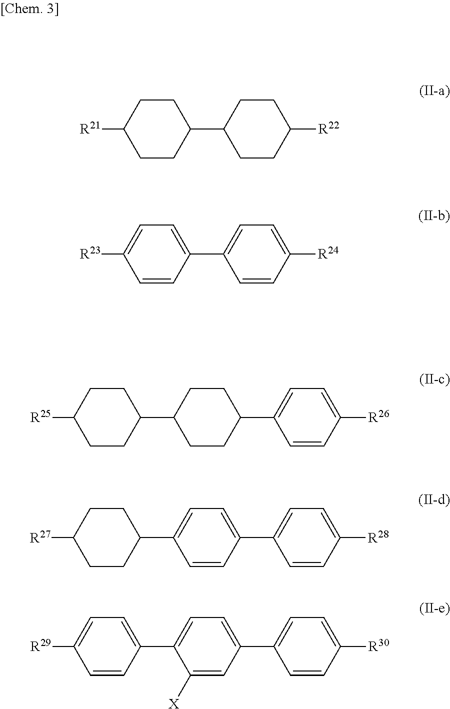

(in the formulae, R²¹ to R³⁰ each independently represent an alkyl group having 1 to 10 carbon atoms or an alkenyl group having 2 to 10 carbon atoms, and X²¹ represents a hydrogen atom or a fluorine atom), wherein an dielectric anisotropy (Δ∈) at 25° C. is +3.5 or more. There is also provided a liquid crystal display device that uses the liquid crystal composition.

### Advantageous Effects of Invention

The liquid crystal composition whose Δ∈ is positive according to the present invention has a very low viscosity, high solubility at low temperature, and resistivity and voltage holding ratio that hardly change due to heat and light. Therefore, the liquid crystal composition is practically used for products. Liquid crystal display devices with an IPS mode, an FFS mode, or the like that use the liquid crystal composition are very useful because high-speed response can be achieved and generation of display defects is reduced.

### DESCRIPTION OF EMBODIMENTS

The liquid crystal composition according to the present invention contains, as a first component, compounds represented by general formula (I-1) to general formula (I-3).

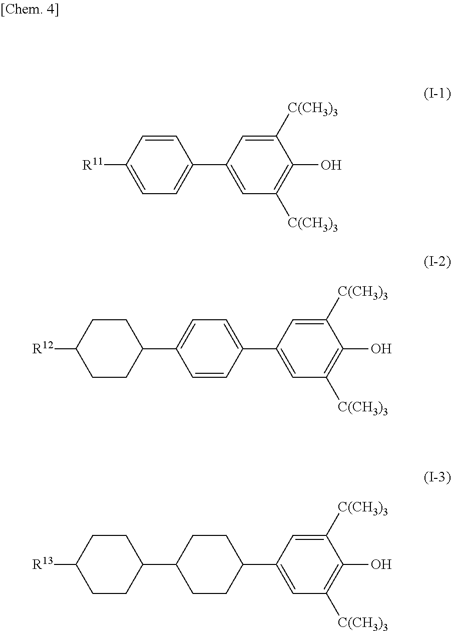

R¹¹ to R¹³ represent an alkyl group or alkoxy group having 1 to 22 carbon atoms, preferably represent an alkyl group or alkoxy group having 1 to 10 carbon atoms, and more preferably represent an alkyl group or alkoxy group having 1 to 5 carbon atoms.
Among the compounds represented by the general formula (I-1) to the general formula (I-3), when an importance is given to the solubility in the liquid crystal composition, compounds represented by the general formula (I-1) are preferred. When an importance is given to the stability of the liquid crystal composition against heat and light, compounds represented by the general formula (I-3) are preferred. The liquid crystal composition according to the present invention preferably contains 1 or 2 of the compounds represented by the general formula (I-1) to the general formula (I-3) and more preferably contains 1 to 5 of the compounds. The content of the compounds is preferably 0.001 to 1 mass %, more preferably 0.001 to 0.1 mass %, and particularly preferably 0.001 to 0.05 mass %.

The liquid crystal composition according to the present invention contains, as a second component, compounds represented by general formula (II-a) to general formula (II-e).

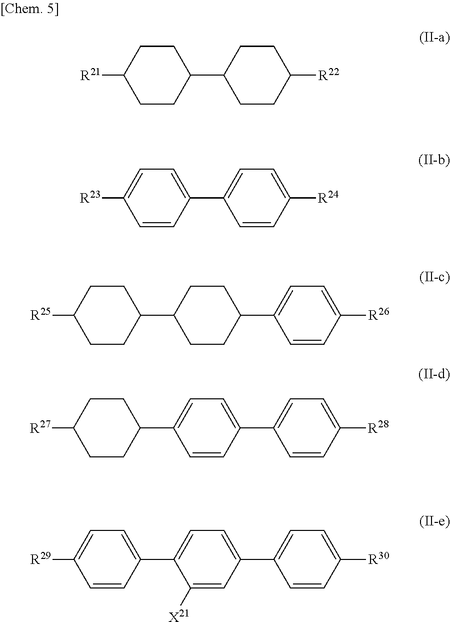

In the formulae, R²¹ to R³⁰ each independently represent an alkyl group having 1 to 10 carbon atoms or an alkenyl group having 2 to 10 carbon atoms. X²¹ represents a hydrogen atom or a fluorine atom and preferably represents a fluorine atom. The liquid crystal composition preferably contains 1 to 10 of the compounds represented by the general formula (II) and particularly preferably 1 to 8 of the compounds. The content of the compounds is 5 to 80 mass %, preferably 10 to 70 mass %, and particularly preferably 20 to 60 mass %. The liquid crystal composition according to the present invention preferably further contains compounds represented by general formula (III)

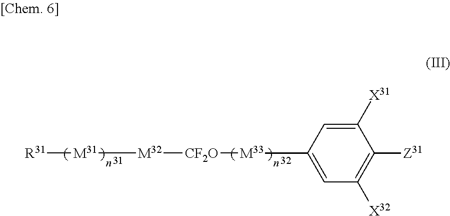

as a third component, as a third component.

In the compounds represented by the general formula (III), R³¹ represents an alkyl group or alkoxy group having 1 to 10 carbon atoms or an alkenyl group or alkenyloxy group having 2 to 10 carbon atoms. M³¹ to M³³ each independently represent a trans-1,4-cyclohexylene group or a 1,4-phenylene group, one or two —CH₂— in the trans-1,4-cyclohexylene group may be substituted with —O— as long as oxygen atoms are not directly adjacent to each other, and one or two hydrogen atoms in the phenylene group may be substituted with fluorine atoms. X³¹ and X³² each independently represent a hydrogen atom or a fluorine atom; Z³¹ represents a fluorine atom, a trifluoromethoxy group, or a trifluoromethyl group; n³¹ and n³² each independently represent 0, 1, or 2; n³¹+n³² represents 0, 1, or 2; and when a plurality of M³¹ and M³³ are present, the plurality of M³¹ may be the same or different and the plurality of M³³ may be the same or different.

More specifically, the compounds represented by the general formula (III) are preferably compounds represented by general formula (III-a) to general formula (III-e) below.

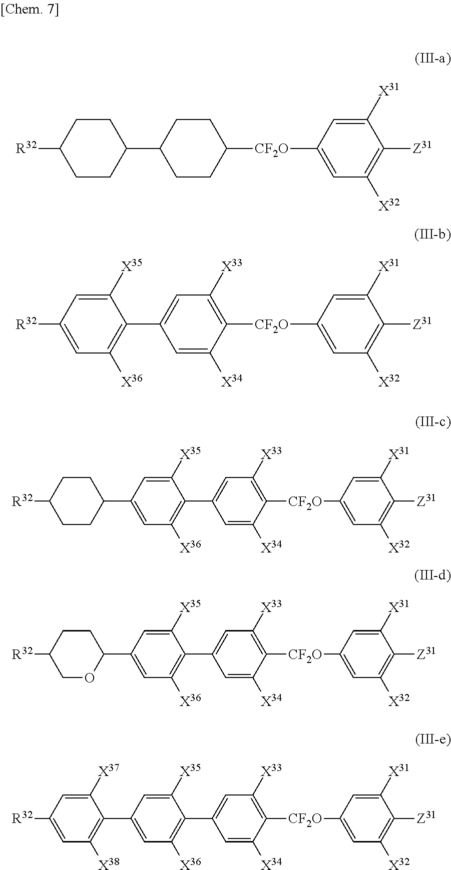

(In the formulae, R³¹ represents an alkyl group or alkoxy group having 1 to 10 carbon atoms or an alkenyl group or alkenyloxy group having 2 to 10 carbon atoms; X³¹ to X³⁸ each independently represent a hydrogen atom or a fluorine atom; and Z³¹ represents a fluorine atom, a trifluoromethoxy group, or a trifluoromethyl group.)

The liquid crystal composition preferably contains 1 to 8 of the compounds represented by the general formula (III) and particularly preferably contains 1 to 5 of the compounds. The content of the compounds is 3 to 50 mass % and preferably 5 to 40 mass %.

The liquid crystal composition according to the present invention may further contain, as a fourth component, compounds selected from the group of compounds represented by general formula (IV-a) to general formula (IV-f).

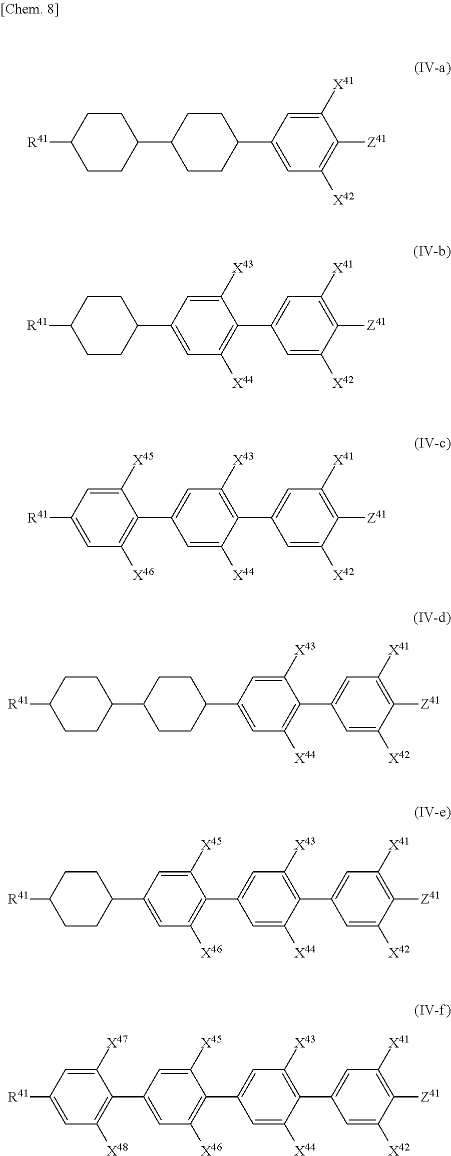

(In the formulae, R⁴¹ represents an alkyl group or alkoxy group having 1 to 10 carbon atoms or an alkenyl group or alkenyloxy group having 2 to 10 carbon atoms; X⁴¹ to X⁴⁸ each independently represent a hydrogen atom or a fluorine atom; and Z⁴¹ represents a fluorine atom, a trifluoromethoxy group, or a trifluoromethyl group.) The liquid crystal composition preferably contains 1 to 10 of the compounds and particularly preferably 1 to 8 of the compounds. The content of the compounds is preferably 5 to 50 mass % and more preferably 10 to 40 mass %.

In the liquid crystal composition according to the present invention, Δ∈ at 25° C. is +3.5 or more and preferably +3.5 to +15.0, and Δn at 25° C. is 0.08 to 0.14 and preferably 0.09 to 0.13. More specifically, Δn is preferably 0.10 to 0.13 when a small cell gap is employed and 0.08 to 0.10 when a large cell gap is employed. At 20° C., η is 10 to 45 mPa·s, preferably 10 to 25 mPa·s, and particularly preferably 10 to 20 mPa·s. Tₙᵢ is 60° C. to 120° C., preferably 70° C. to 100° C., and particularly preferably 70° C. to 85° C.

In addition to the above compounds, the liquid crystal composition according to the present invention may contain, for example, typical nematic liquid crystal, smectic liquid crystal, and cholesteric liquid crystal.

The liquid crystal composition according to the present invention may contain a polymerizable compound for the purpose of producing a liquid crystal display device with, for example, a PS mode, a transverse electric field-type PSA mode, or a transverse electric field-type PSVA mode. For example, a photopolymerizable monomer whose polymerization proceeds with energy rays such as light can be used as the polymerizable compound. In terms of structure, a polymerizable compound having a liquid crystal skeleton formed by bonding a plurality of six-membered rings, such as a biphenyl derivative or a terphenyl derivative, is exemplified. More specifically, the polymerizable compound is preferably a bifunctional monomer represented by general formula (V).

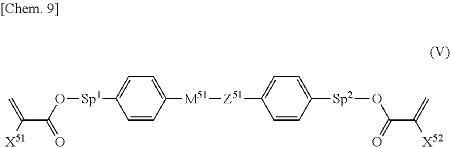

(In the formula, X⁵¹ and X⁵² each independently represent a hydrogen atom or a methyl group; Sp¹ and Sp² each independently represent a single bond, an alkylene group having 1 to 8 carbon atoms, or —O—(CH₂)ₛ— (in the formula, s represents an integer of 2 to 7, and an oxygen atom bonds to an aromatic ring);
Z⁵¹ represents —OCH₂—, —CH₂O, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond; and
M⁵¹ represents a 1,4-phenylene group, a trans-1,4-cyclohexylene group, or a single bond, and, in all the 1,4-phenylene groups in the formula, any of hydrogen atoms may be substituted with fluorine atoms.)

The polymerizable compound is preferably any of a diacrylate derivative in which X⁵¹ and X⁵² each represent a hydrogen atom and a dimethacrylate derivative in which X⁵¹ and X⁵² each represent a methyl group, and is also preferably a compound in which one of X⁵¹ and X⁵² represents a hydrogen atom and the other represents a methyl group. Among these compounds, the diacrylate derivative has the highest rate of polymerization, the dimethacrylate derivative has a low rate of polymerization, and the asymmetrical compound has an intermediate rate of polymerization. A preferred one can be used in accordance with the applications. In a PSA display device, the dimethacrylate derivative is particularly preferably used.

Sp¹ and Sp² each independently represent a single bond, an alkylene group having 1 to 8 carbon atoms, or —O— (CH₂)ₛ—. In a PSA display device, at least one of Sp¹ and Sp² preferably represents a single bond. A compound in which Sp¹ and Sp² each represent a single bond or a compound in which one of Sp¹ and Sp² represents a single bond and the other represents an alkylene group having 1 to 8 carbon atoms or —O—(CH₂)ₛ— is preferred. In this case, an alkyl group having 1 to 4 carbon atoms is preferred and s is preferably 1 to 4.

Z⁵¹ preferably represents —OCH₂—, —CH₂O—, —COO—, —OCO—, —CF₂O—, —OCF₂—, —CH₂CH₂—, —CF₂CF₂—, or a single bond, more preferably represents —COO—, —OCO—, or a single bond, and particularly preferably represents a single bond.

M⁵¹ represents a 1,4-phenylene group in which any of hydrogen atoms may be substituted with fluorine atoms, a trans-1,4-cyclohexylene group, or a single bond and preferably represents the 1,4-phenylene group or a single bond. When C represents a ring structure other than a single bond, Z⁵¹ preferably also represents a linking group other than a single bond. When M⁵¹ represents a single bond, Z⁵¹ preferably represents a single bond.

In view of the foregoing, the ring structure between Sp¹ and Sp² in the general formula (V) is preferably the following structure.

In the case where M⁵¹ represents a single bond and the ring structure is constituted by two rings in the general formula (V), the ring structure is preferably represented by formula (Va-1) to formula (Va-5) below, more preferably represented by formula (Va-1) to formula (Va-3), and particularly preferably represented by formula (Va-1).

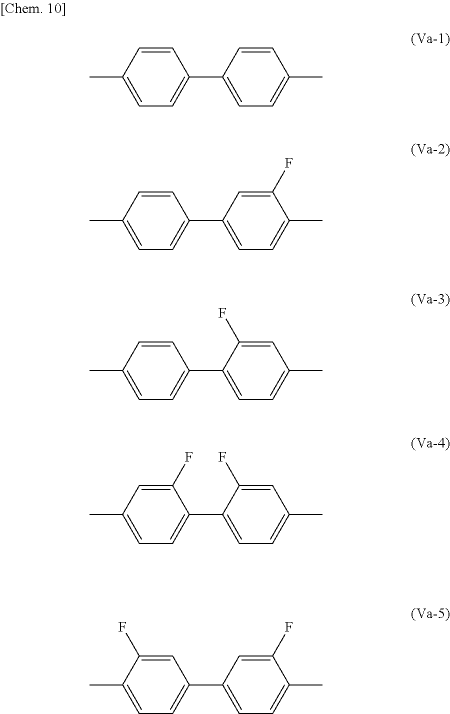

(In formulae, both ends bond to Sp¹ and Sp².)

The anchoring strength after the polymerization of the polymerizable compound having such a skeleton is optimum for PSA mode liquid crystal display devices, and a good alignment state is achieved. Therefore, the display unevenness is reduced or completely prevented.

Accordingly, the polymerizable monomer is particularly preferably represented by general formula (V-1) to general formula (V-4) and most preferably represented by general formula (V-2).

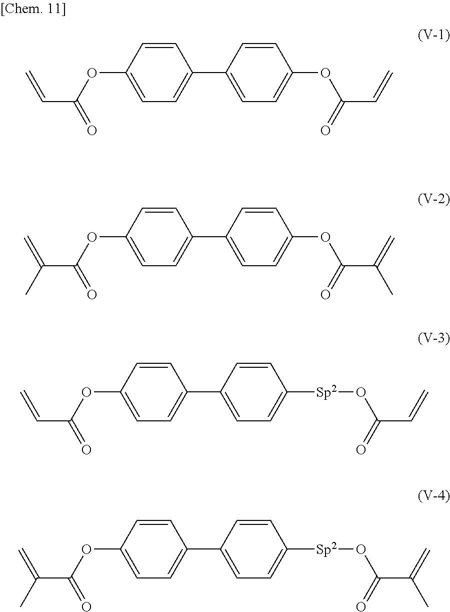

(In the formulae, Sp² represents an alkylene group having 2 to 5 carbon atoms.)

In the case where the monomer is added to the liquid crystal composition of the present invention, polymerization proceeds without a polymerization initiator, but a polymerization initiator may be contained to facilitate the polymerization. Examples of the polymerization initiator include benzoin ethers, benzophenones, acetophenones, benzylketals, and acylphosphine oxides.

The liquid crystal composition containing the polymerizable compound according to the present invention is provided with liquid crystal alignment capability by polymerizing the polymerizable compound through irradiation with ultraviolet rays and is used for liquid crystal display devices that control the amount of transmitted light by using the birefringence of the liquid crystal composition. The liquid crystal composition is useful for liquid crystal display devices such as an AM-LCD (active matrix liquid crystal display device), a TN (nematic liquid crystal display device), an STN-LCD (super-twisted nematic liquid crystal display device), an OCB-LCD, and an IPS-LCD (in-plane switching liquid crystal display device). The liquid crystal composition is particularly useful for AM-LCDs and can be used for transmission or reflection-type liquid crystal display devices.

Two substrates of a liquid crystal cell used in a liquid crystal display device may be made of glass or a flexible transparent material such as a plastic material. One of the substrates may be made of an opaque material such as silicon. A transparent substrate including a transparent electrode layer can be produced by, for example, sputtering indium tin oxide (ITO) on a transparent substrate such as a glass plate.

A color filter can be produced by, for example, a pigment dispersion method, a printing method, an electrodeposition method, or a staining method. A method for producing a color filter will be described by taking the pigment dispersion method as an example. A curable coloring composition for color filters is applied onto the above-described transparent substrate and patterned. The curable coloring composition is then cured by heating or light irradiation. This process is performed for each of three colors of red, green, and blue. Thus, pixel portions of the color filter can be formed. Furthermore, pixel electrodes each including an active element such as a TFT, a thin-film diode, or a metal-insulator-metal resistivity element may be disposed on the substrate.

The substrates are arranged so as to face each other such that the transparent electrode layer is disposed inside. Herein, the gap between the substrates may be adjusted with a spacer disposed therebetween. In this case, the gap is preferably adjusted so that the thickness of a light-modulating layer obtained is 1 to 100 μm, and more preferably 1.5 to 10 μm. When a polarizing plate is used, it is preferable to adjust the product of the refractive index anisotropy Δn of the liquid crystal and a cell thickness d so that the maximum contrast is achieved. When two polarizing plates are used, the polarizing axis of each of the polarizing plates may be adjusted so that a satisfactory viewing angle and contrast can be achieved. Furthermore, a retardation film for widening the viewing angle may also be used. Examples of the spacer include glass particles, plastic particles, alumina particles, and a photoresist material. Subsequently, a sealant such as an epoxy thermosetting composition is applied onto the substrate by screen printing while a liquid-crystal injection port is formed. The substrates are bonded to each other, and the sealant is thermally cured by heating.

A commonly used vacuum injection method, an ODF method, or the like can be employed as a method for interposing the polymerizable compound-containing liquid crystal composition between the two substrates. In the vacuum injection method, although drop marks are not generated, this method poses a problem in that marks of injection are left. However, in the present invention, the liquid crystal composition can be suitably used for display devices produced by using the ODF method.

As a method for polymerizing the polymerizable compound, a method in which polymerization is conducted by irradiation with active energy rays such as ultraviolet rays and electron beams, which can be used alone, in combination, or sequentially, is preferred because a moderate rate of polymerization is desirable in order to achieve good liquid crystal alignment capability. In the case where ultraviolet rays are used, either a polarized light source or an unpolarized light source may be used. When polymerization is conducted while the polymerizable compound-containing liquid crystal composition is interposed between the two substrates, it is necessary that at least a substrate on the irradiation surface side have transparency appropriate for the active energy rays. Alternatively, only particular portions may be polymerized using a mask during light irradiation, and unpolymerized portions may then be polymerized by further irradiation with active energy rays while the alignment state of the unpolymerized portions is changed by changing a condition such as an electric field, a magnetic field, or a temperature. In particular, when ultraviolet exposure is performed, the ultraviolet exposure is preferably performed while an alternating electric field is applied to the polymerizable compound-containing liquid crystal composition. Regarding the alternating electric field applied, an alternating current having a frequency of preferably 10 Hz to 10 kHz and more preferably 60 Hz to 10 kHz is applied, and the voltage applied is determined in accordance with a desired pre-tilt angle of the liquid crystal display device. That is, the pre-tilt angle of the liquid crystal display device can be controlled by controlling the voltage applied. In a transverse electric field-type MVA mode liquid crystal display device, it is preferable to control the pre-tilt angle to 80 to 89.9 degrees from the viewpoint of the alignment stability and the contrast.

The temperature during the irradiation is preferably within a temperature range in which the liquid crystal state of the liquid crystal composition according to the present invention is maintained. Polymerization is preferably conducted at a temperature close to room temperature, that is, typically at a temperature of 15° C. to 35° C. A metal halide lamp, a high-pressure mercury lamp, an ultrahigh-pressure mercury lamp, or the like can be used as a lamp for generating ultraviolet rays. Regarding the wavelength of ultraviolet rays for irradiation, it is preferable to perform irradiation with ultraviolet rays in a wavelength range which is not included in an absorption wavelength range of the liquid crystal composition. When necessary, part of the ultraviolet rays is preferably cut off and used. The intensity of ultraviolet rays for irradiation is preferably 0.1 mW/cm² to 100 W/cm² and more preferably 2 mW/cm² to 50 W/cm². The amount of energy of the ultraviolet rays for irradiation can be appropriately adjusted, and is preferably 10 mJ/cm² to 500 J/cm² and more preferably 100 mJ/cm² to 200 J/cm². During the irradiation with ultraviolet rays, the intensity of the ultraviolet rays may be changed. The ultraviolet-irradiation time is appropriately selected in accordance with the intensity of the ultraviolet rays for irradiation, and is preferably 10 to 3600 seconds and more preferably 10 to 600 seconds.

The liquid crystal display device using the liquid crystal composition according to the present invention is a useful display device which achieves high-speed response and reduces display defects. The liquid crystal display device is particularly useful as an active matrix driving liquid crystal display device and can be applied to a VA mode, PSVA mode, PSA mode, IPS mode, or ECB mode liquid crystal display device.

### EXAMPLES

The present invention will now be further described in detail on the basis of Examples, but the present invention is not limited to Examples. In compositions of Examples and Comparative Examples below, “%” means “% by mass”.

In Examples, the measured properties are as follows.

Tₙᵢ: nematic phase-isotropic liquid phase transition temperature (° C.)

Δn: refractive index anisotropy at 25° C.

Δ∈: dielectric anisotropy at 25° C.

η: viscosity (mPa·s) at 20° C.

γ1: rotational viscosity (mPa·s) at 25° C.

VHR: voltage holding ratio (%) at 60° C. under conditions of a frequency of 60 Hz and an applied voltage of 1 V

Image Sticking:

Image sticking evaluation for a liquid crystal display device was performed by performing uniform display on the entire screen after displaying a particular fixed pattern in a display area for 1000 hours, and visually evaluating the degree of the afterimage of the fixed pattern on the basis of the four-grade evaluation below.

A: No afterimage was observed.

B: Faint afterimage was observed but the degree of the afterimage was acceptable.

C: Afterimage was observed and the degree of the afterimage was unacceptable.

D: Very poor afterimage was observed.

Drop Mark:

Drop mark evaluation for the liquid crystal display device was performed by visually evaluating a drop mark that appeared white on a full black screen on the basis of the four-grade evaluation below.

A: No afterimage was observed.

B: Faint afterimage was observed but the degree of the afterimage was acceptable.

C: Afterimage was observed and the degree of the afterimage was unacceptable.

D: Very poor afterimage was observed.

In Examples, the following abbreviations are used to describe compounds.

### (Ring Structure)

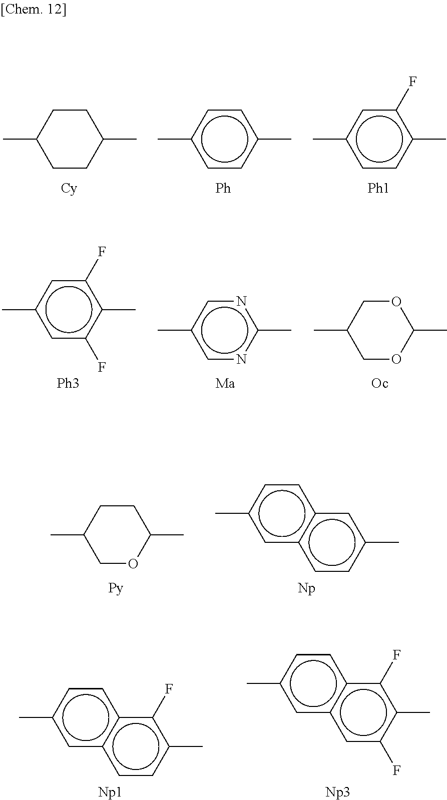

### (Side Chain Structure and Linking Structure)

TABLE 1

| | |
|---|---|
| n (number) at terminal | CₙH₂ₙ₊₁— |
| -2- | —CH₂CH₂— |
| —1O— | —CH₂O— |
| —O1— | —OCH₂— |
| —V— | —CO— |
| —VO— | —COO— |
| —CFFO— | —CF₂O— |
| —F | —F |
| —Cl | —Cl |
| —CN | —C≡N |
| —OCFFF | —OCF₃ |
| —CFFF | —CF₃ |
| —On | —OCₙH₂ₙ₊₁— |
| -T- | —C≡C— |
| ndm- | CₙH₂ₙ₊₁—HC═CH—(CH₂)ₘ₋₁— |
| -ndm | —(CH₂)ₙ₋₁—HC═CH—CₘH₂ₘ₊₁ |
| ndmO— | CₙH₂ₙ₊₁—HC═CH—(CH₂)ₘ₋₁O— |
| —Ondm | —O—(CH₂)ₙ₋₁—HC═CH—CₘH₂ₘ₊₁ |
| -ndm- | —(CH₂)ₙ₋₁—HC═CH— (CH₂)ₘ₋₁— |

### Example 1

A liquid crystal composition LC-1 shown below was prepared.

[Chem. 13]

| Chemical structure | Proportion | Abbreviation |
|---|---|---|
| 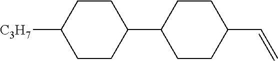 | 48% | 3-Cy-Cy-1d0 |
| 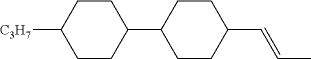 | 4% | 3-Cy-Cy-1d1 |
| 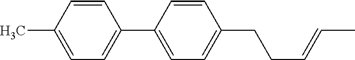 [SMILES: C/C=C/CCc1ccc(-c2ccc(C)cc2)cc1] | 8% | 1-Ph—Ph-3d1 |
| 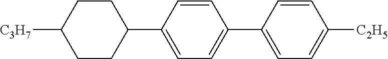 | 5% | 3-Cy-Ph—Ph-2 |
| 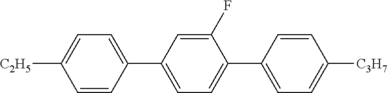 | 5% | 2-Ph—Ph1—Ph-3 |
| 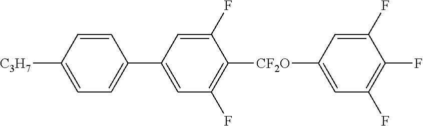 | 2% | 3-Ph—Ph3—CFFO—Ph3—F |
| 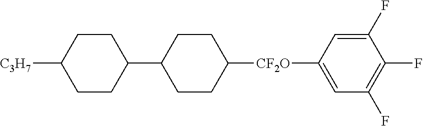 | 3% | 3-Cy-Cy-CFFO—Ph3—F |
| 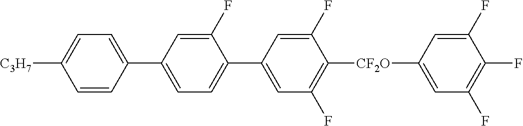 | 7% | 3-Ph—Ph1—Ph3—CFFO—Ph3—F |
| 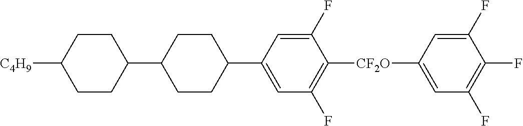 | 5% | 4-Cy-Cy-Ph3—CFFO—Ph3—F |

The physical properties of LC-1 were as follows.

TABLE 2

| | |
|---|---|
| T_{NI}/° C. | 75.8 |
| Δn | 0.112 |
| no | 1.488 |
| ε_{⊥} | 5.5 |
| Δε | 2.9 |
| η/mPa · s | 13.5 |

A liquid crystal composition LCM-1 was prepared by adding 0.03% of a compound represented by formula (I-1-1) to 99.97% of the liquid crystal composition LC-1.

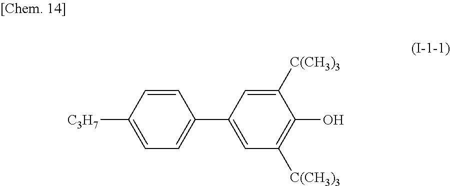

The physical properties of LCM-1 were substantially the same as those of LC-1. The initial VHR of the liquid crystal composition LCM-1 was 99.3% whereas the VHR after the liquid crystal composition LCM-1 was left to stand at a high temperature of 150° C. for 1 hour was 98.8%. An IPS mode liquid crystal display device was produced using the liquid crystal composition LCM-1, and the image sticking and the drop mark were evaluated by the above-described methods. The evaluation results were excellent as shown below.

TABLE 3

| | |
|---|---|
| Drop mark evaluation | A |
| Image sticking evaluation | A |

### Comparative Example 1

The initial VHR of the liquid crystal composition LC-1, to which the compound represented by the formula (I-1-1) in Example 1 was not added, was 99.5% whereas the VHR after the liquid crystal composition LC-1 was left to stand at a high temperature of 150° C. for 1 hour was 87.2%, which was much lower than the initial VHR.

A VA mode liquid crystal display device was produced using the liquid crystal composition LC-1, and the image sticking and the drop mark were evaluated by the above-described methods. The evaluation results were poorer than those of Example 1 as shown below.

TABLE 4

| | |
|---|---|
| Drop mark evaluation | C |
| Image sticking evaluation | D |

### Comparative Example 2

A liquid crystal composition LC-2 that is shown below and does not contain the compounds represented by the general formula (II) was prepared.

[Chem. 15]

| Chemical structure | Proportion | Abbreviation |
|---|---|---|
| 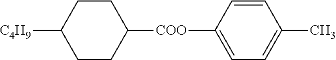 | 27% | 4-Cy-VO—Ph-1 |
| 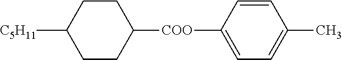 | 20% | 5-Cy-VO—Ph-1 |
| 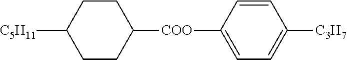 | 20% | 5-Cy-VO—Ph-3 |
| 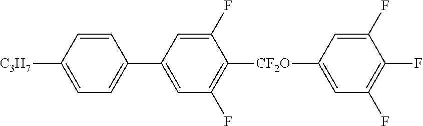 | 8% | 3-Ph—Ph3—CFFO—Ph3—F |
| 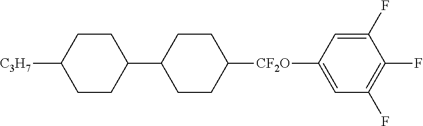 | 13% | 3-Cy-Cy-CFFO—Ph3—F |
| 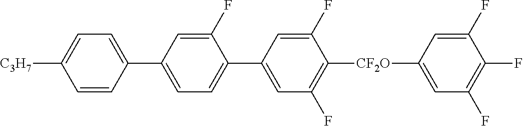 | 12% | 3-Ph—Ph1—Ph3—CFFO—Ph3—F |

The physical properties of LC-2 were as follows.

TABLE 5

| | |
|---|---|
| T_{NI}/° C. | 69.3 |
| Δn | 0.096 |
| no | 1.484 |
| ε_{⊥} | 5.5 |
| Δε | 4.8 |
| η/mPa · s | 30.3 |

A liquid crystal composition LCM-A was prepared by adding 0.03% of a compound represented by the formula (I-1-1) to 99.97% of the liquid crystal composition LC-A. The physical properties of LCM-A were substantially the same as those of LC-A. In the liquid crystal composition LCM-A not containing the compounds represented by the general formula (II), the viscosity η was considerably increased compared with the liquid crystal composition LCM-1 containing the compounds represented by the general formula (II). The initial VHR of the liquid crystal composition LCM-A was 92.3% whereas the VHR after the liquid crystal composition LCM-A was left to stand at a high temperature of 150° C. for 1 hour was 67.0%.

An IPS mode liquid crystal display device was produced using the liquid crystal composition LCM-A, and the image sticking and the drop mark were evaluated by the above-described methods. The evaluation results were poorer than those of Example 1 as shown below.

TABLE 6

| | |
|---|---|
| Drop mark evaluation | D |
| Image sticking evaluation | D |

### Example 2 to Example 4

Liquid crystal compositions LC-2 to LC-4 shown below were prepared, and the physical properties were measured. Table 7 shows the results.

TABLE 7

| | | | | | |
|---|---|---|---|---|---|
| T_{NI}/° C. | 101 | T_{NI}/° C. | 100.7 | T_{NI}/° C. | 103.2 |
| Δn | 0.095 | Δn | 0.094 | Δn | 0.102 |
| Δε | 82 | Δε | 8.0 | Δε | 7.1 |
| η/mPa · s | 23.6 | η/mPa · s | 22.2 | η/mPa · s | 20.8 |
| Υ₁/mPa · s | 115 | Υ₁/mPa · s | 108 | Υ₁/mPa · s | 96 |
| 4-Cy—Cy-1d0 | 15% | 4-Cy—Cy-1d0 | 15% | 5-Cy—Cy-1d0 | 5% |
| 0d1-Cy—Cy—Ph-1 | 4% | 0d1-Cy—Cy—Ph-1 | 4% | 3-Cy—Cy-1d1 | 10% |
| 0d3-Cy—Cy—Ph-1 | 14% | 0d3-Cy—Cy—Ph-1 | 14% | 0d1-Cy—Cy—Ph-1 | 8% |
| 3-Cy—Ph—Ph—Cy-3 | 3% | 3-Cy—Ph—Ph—Cy-3 | 3% | 5-Cy—Cy—Ph—O1 | 6% |
| 3-Cy—Ph—Ph1—Cy-3 | 4% | 3-Cy—Ph—Ph1—Cy-3 | 4% | 2-Ph—Ph1—Ph-3 | 8% |
| 1-Cy—Cy—Ph3—F | 9% | 1-Cy—Cy—Ph3—F | 9% | 2-Cy—Cy—Ph3—F | 11% |
| 2-Cy—Cy—Ph3—F | 10% | 2-Cy—Cy—Ph3—F | 10% | 3-Cy—Cy—Ph3—F | 15% |
| 3-Cy—Cy—Ph3—F | 10% | 3-Cy—Cy—Ph3—F | 10% | 5-Cy—Cy—Ph3—F | 5% |
| 5-Cy—Cy—Ph3—F | 5% | 5-Cy—Cy—Ph3—F | 5% | 3-Cy—Ph—Ph3—F | 6% |
| 3-Cy—Ph1—Ph3—F | 8% | 0d1-Cy—Cy—Ph1—F | 8% | 3-Cy—Ph—Ph1—F | 9% |
| 5-Cy—Ph1—Ph3—F | 7% | 3-Cy—Cy—Ph1—Ph3—F | 8% | 4-Cy—Cy—Ph—OCFFF | 4% |
| 3-Ph—Ph1—Ph3—F | 3% | 2-Ph—Ph3—CFFO—Ph3—F | 4% | 3-Cy—Cy—CFFO—Ph3—F | 7% |
| 3-Cy—Cy—Ph1—Ph3—F | 8% | 3-Ph—Ph3—CFFO—Ph3—F | 6% | 5-Cy—Cy—CFFO—Ph3—F | 4% |
| | | | | 3-Cy—Cy—Ph1—Ph3—F | 2% |

Liquid crystal compositions LCM-2 to LCM-4 were prepared by adding 0.03% of the compound represented by the formula (I-1-1) to 99.97% of the liquid crystal compositions LC-2 to LC-4, respectively. The physical properties of LCM-2 to LCM-4 were substantially the same as those of LC-2 to LC-4.

The initial VHRs of the liquid crystal compositions LCM-2 to LCM-4 were substantially the same as the VHRs after they were left to stand at a high temperature of 150° C. for 1 hour. An IPS mode liquid crystal display device was produced using each of the liquid crystal compositions LCM-2 to LCM-4, and the image sticking and the drop mark were evaluated. The evaluation results were excellent as shown below.

TABLE 8

| | LCM-2 | LCM-3 | LCM-4 |
|---|---|---|---|
| Initial VHR (%) | 98.5 | 98.5 | 98.4 |
| VHR (%) after 150° C. for 1 hour | 98.1 | 98.2 | 98.0 |
| Drop mark evaluation | A | A | A |
| Image sticking evaluation | A | A | A |

### Example 5 to Example 7

Liquid crystal compositions LC-5 to LC-7 shown below were prepared, and the physical properties were measured. Table 9 shows the results.

TABLE 9

| | | | | | |
|---|---|---|---|---|---|
| T_{NI}/° C. | 90.2 | T_{NI}/° C. | 110 | T_{NI}/° C. | 77.4 |
| Δn | 0.098 | Δn | 0.0990 | Δn | 0.1010 |
| Δε | 9.1 | Δε | 8.3 | Δε | 7.0 |
| η/mPa · s | 18.1 | η/mPa · s | 23.4 | η/mPa · s | 14.2 |
| γ₁/ mPa · s | 90 | γ₁/ mPa · s | 112 | γ₁/ mPa · s | 86 |
| 5-Cy-Cy-1d0 | 15% | 5-Cy-Cy-1d0 | 10% | 5-Cy-Cy-1d0 | 12% |
| 3-Cy-Cy-1d1 | 2% | 3-Cy-Cy-1d1 | 5% | 3-Cy-Cy-1d0 | 25% |
| 0d1-Cy-Cy-Ph-1 | 12% | 0d1-Cy-Cy-Ph-1 | 8% | 3-Cy-Cy-1d1 | 12% |
| 2-Ph-Ph1-Ph-3 | 3% | 0d3-Cy-Cy-Ph-1 | 12% | 0d1-Cy-Cy-Ph-1 | 4% |
| 2-Ph-Ph1-Ph-4 | 3% | 2-Ph-Ph1-Ph-5 | 2% | 0d3-Cy-Cy-Ph-1 | 9% |
| 2-Cy-Cy-Ph3-F | 8% | 3-Cy-Ph-Ph-Cy-3 | 3% | 2-Ph-Ph1-Ph3-F | 5% |
| 2-Cy-Ph-Ph3-F | 3% | 3-Cy-Ph-Ph1-Cy-3 | 3% | 3-Ph-Ph1-Ph3-F | 9% |
| 3-Cy-Ph-Ph3-F | 9% | 1-Cy-Cy-Ph3-F | 9% | 2-Ph-Ph3-CFFO-Ph3-F | 4% |
| 4-Cy-Cy-Ph-OCFFF | 14% | 2-Cy-Cy-Ph3-F | 10% | 3-Ph-Ph3-CFFO-Ph3-F | 6% |
| 3-Ph-Ph3-CFFO-Ph3-F | 11% | 3-Cy-Cy-Ph3-F | 6% | 3-Cy-Cy-CFFO-Ph3-F | 2% |
| 2-Cy-Cy-CFFO-Ph3-F | 9% | 5-Cy-Cy-Ph3-F | 5% | 5-Cy-Cy-CFFO-Ph3-F | 3% |
| 3-Cy-Cy-CFFO-Ph3-F | 8% | 0d1-Cy-Cy-Ph1-F | 8% | 3-Cy-Cy-Ph1-Ph3-F | 9% |
| 3-Cy-Cy-Ph1-Ph3-F | 3% | 2-Ph-Ph3-CFFO-Ph3-F | 4% | | |
| | | 3-Ph-Ph3-CFFO-Ph3-F | 6% | | |
| | | 3-Cy-Cy-Ph1-Ph3-F | 9% | | |

Liquid crystal compositions LCM-5 to LCM-7 were prepared by adding 0.03% of the compound represented by the formula (I-1-1) to 99.97% of the liquid crystal compositions LC-5 to LC-7, respectively. The physical properties of LCM-5 to LCM-7 were substantially the same as those of LC-5 to LC-7.

The initial VHRs of the liquid crystal compositions LCM-5 to LCM-7 were substantially the same as the VHRs after they were left to stand at a high temperature of 150° C. for 1 hour. An IPS mode liquid crystal display device was produced using each of the liquid crystal compositions LCM-5 to LCM-7, and the image sticking and the drop mark were evaluated. The evaluation results were excellent as shown below.

TABLE 10

| | LCM-5 | LCM-6 | LCM-7 |
|---|---|---|---|
| Initial VHR (%) | 98.5 | 98.5 | 98.4 |
| VHR (%) after 150° C. for 1 hour | 98.0 | 98.2 | 98.0 |
| Drop mark evaluation | A | A | A |
| Image sticking evaluation | A | A | A |

### Example 8 to Example 10

Liquid crystal compositions LC-8 to LC-10 shown below were prepared, and the physical properties were measured. Table 11 shows the results.

TABLE 11

| | | | | | |
|---|---|---|---|---|---|
| T_{NI}/° C. | 76.0 | T_{NI}/° C. | 81.8 | T_{NI}/° C. | 75.0 |
| Δn | 0.097 | Δn | 0.099 | Δn | 0.112 |
| Δε | 6.8 | Δε | 8.0 | Δε | 8.7 |
| η/mPa · s | 14.5 | η/mPa · s | 14.6 | η/mPa · s | 15.2 |
| Υ₁/mPa · s | 83 | Υ₁/mPa · s | 83 | Υ₁/mPa · s | 87 |
| 3-Cy—Cy-1d0 | 38% | 3-Cy—Cy-1d0 | 38% | 3-Cy—Cy-1d0 | 30% |
| 3-Cy—Cy-1d1 | 9% | 3-Cy—Cy-1d1 | 14% | 3-Cy—Cy-1d1 | 17% |
| 0d1-Cy—Cy—Ph-1 | 16% | 0d3-Cy—Cy—Ph-1 | 8% | 0d1-Cy—Cy—Ph-1 | 7% |
| 0d3-Cy—Cy—Ph-1 | 4% | 3-Ph—Ph3—CFFO—Ph3—F | 9% | 0d3-Cy—Cy—Ph-1 | 7% |
| 2-Ph—Ph3—CFFO—Ph3—F | 2% | 3-Cy—Cy—CFFO—Ph3—F | 15% | 3-Cy—Cy—Ph-2 | 2% |
| 3-Ph—Ph3—CFFO—Ph3—F | 12% | 3-Ph—Ph1—Ph3—CFFO—Ph3—F | 2% | 2-Ph—Ph1—Ph-4 | 2% |
| 3-Cy—Cy—CFFO—Ph3—F | 7% | 4-Ph—Ph1—Ph3—CFFO—Ph3—F | 7% | 2-Ph—Ph1—Ph3—F | 8% |
| 3-Ph—Ph—Ph1—Ph3—F | 1% | 5-Ph—Ph1—Ph3—CFFO—Ph3—F | 7% | 3-Ph—Ph1—Ph3—F | 12% |
| 3-Ph—Ph1—Ph3—CFFO—Ph3—F | 2% | | | 3-Ph—Ph3—Ph3—F | 4% |
| 2-Py—Ph—Ph3—CFFO—Ph3—F | 3% | | | 3-Cy—Cy—Ph1—CFFO—Ph3—F | 11% |
| 2-Py—Ph—Ph3—CFFO—Ph3—F | 6% | | | | |

Liquid crystal compositions LCM-8 to LCM-10 were prepared by adding 0.03% of the compound represented by the formula (I-1-1) to 99.97% of the liquid crystal compositions LC-8 to LC-10, respectively. The physical properties of LCM-8 to LCM-10 were substantially the same as those of LC-8 to LC-10.

The initial VHRs of the liquid crystal compositions LCM-8 to LCM-10 were substantially the same as the VHRs after they were left to stand at a high temperature of 150° C. for 1 hour. An IPS mode liquid crystal display device was produced using each of the liquid crystal compositions LCM-8 to LCM-10, and the image sticking and the drop mark were evaluated. The evaluation results were excellent as shown below.

TABLE 12

| | LCM-8 | LCM-9 | LCM-10 |
|---|---|---|---|
| Initial VHR (%) | 98.5 | 98.5 | 98.5 |
| VHR (%) after 150° C. for 1 hour | 98.1 | 98.2 | 98.1 |
| Drop mark evaluation | A | A | A |
| Image sticking evaluation | A | A | A |

### Example 11 to Example 13

Liquid crystal compositions LC-11 to LC-13 shown below were prepared, and the physical properties were measured. Table 13 shows the results.

TABLE 13

| | | | | | |
|---|---|---|---|---|---|
| T_{NI}/° C. | 76.0 | T_{NI}/° C. | 772 | T_{NI}/° C. | 77.9 |
| Δn | 0.114 | Δn | 0.135 | Δn | 0.131 |
| Δε | 6.0 | Δε | 4.5 | Δε | 4.6 |
| η/mPa · s | 133 | η/mPa · s | 10.5 | η/mPa · s | 12.4 |
| Υ₁/mPa · s | 77 | Υ₁/mPa · s | 57 | Υ₁/mPa · s | 74 |
| 3-Cy—Cy-1d0 | 39% | 2-Cy—Cy-1d0 | 32% | 3-Cy—Cy-1d0 | 44% |
| 3-Cy—Cy-1d1 | 7% | 0d1-Cy—Cy—Ph-1 | 4% | 3-Cy—Cy-1d1 | 3% |
| 0d1-Cy—Cy—Ph-1 | 11% | 2-Ph—Ph1—Ph-3 | 10% | 2-Ph—Ph-3d1 | 13% |
| 2-Ph—Ph1—Ph-3 | 8% | 2-Ph—Ph1—Ph-5 | 11% | 3-Cy—Ph—Ph-2 | 7% |
| 2-Ph—Ph1—Ph-5 | 8% | 3-Ph—Ph1—Ph-5 | 7% | 2-Ph—Ph1—Ph-3 | 8% |
| 3-Ph—Ph3—CFFO—Ph3—F | 10% | 2-Cy—Cy—Ph—F | 6% | 3-Ph—Ph1—Ph-3 | 7% |
| 3-Cy—Cy—Ph—Ph3—F | 6% | 3-Cy—Cy—Ph—F | 21% | 3-Ph—Ph1—Ph3—CFFO—Ph3—F | 9% |
| 4-Ph—Ph1—Ph3—CFFO—Ph3—F | 11% | 5-Cy—Ph—Ph—F | 7% | 4-Cy—Cy—Ph1—CFFO—Ph3—F | 3% |
| | | 3-Cy—Ph—Ph3—F | 2% | 3-Cy—Ph3—Ph1—OCFFF | 6% |

Liquid crystal compositions LCM-11 to LCM-13 were prepared by adding 0.03% of the compound represented by the formula (I-1-1) to 99.97% of the liquid crystal compositions LC-11 to LC-13, respectively. The physical properties of LCM-11 to LCM-13 were substantially the same as those of LC-11 to LC-13.

The initial VHRs of the liquid crystal compositions LCM-11 to LCM-13 were substantially the same as the VHRs after they were left to stand at a high temperature of 150° C. for 1 hour. An IPS mode liquid crystal display device was produced using each of the liquid crystal compositions LCM-11 to LCM-13, and the image sticking and the drop mark were evaluated. The evaluation results were excellent as shown below.

TABLE 14

| | LCM-11 | LCM-12 | LCM-13 |
|---|---|---|---|
| Initial VHR (%) | 98.7 | 98.5 | 98.7 |
| VHR (%) after 150° C. for 1 hour | 98.2 | 98.3 | 98.4 |
| Drop mark evaluation | A | A | A |
| Image sticking evaluation | A | A | A |

### Example 14 to Example 16

Liquid crystal compositions LC-14 to LC-16 shown below were prepared, and the physical properties were measured. Table 15 shows the results.

TABLE 15

| | | | | | |
|---|---|---|---|---|---|
| T_{NI}/° C. | 80.6 | T_{NI}/° C. | 74.9 | T_{NI}/° C. | 80.0 |
| Δn | 0.122 | Δn | 0.121 | Δn | 0.110 |
| Δε | 6.0 | Δε | 4.1 | Δε | 5.9 |
| η/mPa · s | 11.1 | η/mPa · s | 10.8 | η/mPa · s | 11.6 |
| Υ₁/mPa · s | 65 | Υ₁/mPa · s | 60 | Υ₁/mPa · s | 68 |
| 3-Cy—Cy-1d0 | 47% | 3-Cy—Cy-1d0 | 29% | 3-Cy—Cy-1d0 | 10% |
| 3-Cy—Cy-1d1 | 9% | 5-Cy—Cy-0d1 | 8% | 3-Cy—Cy-1d1 | 6% |
| 3-Cy—Cy—Ph-2 | 7% | 3-Cy—Cy-1d1 | 13% | 3-Cy—Cy-1d1-F | 28% |
| 2-Ph—Ph1—Ph-3 | 4% | 5-Ph—Ph-1 | 2% | 0d1-Cy—Cy—Ph-1 | 11% |
| 2-Ph—Ph1—Ph-5 | 7% | 2-Ph—Ph1—Ph-3 | 6% | 0d3-Cy—Cy—Ph-1 | 10% |
| 3-Cy—Ph—Ph—Cy-3 | 2% | 2-Ph—Ph1—Ph-4 | 6% | 2-Ph—Ph1—Ph-3 | 10% |
| 2-Ph—Ph1—Ph-3 | 6% | 2-Ph—Ph1—Ph-5 | 6% | 2-Ph—Ph1—Ph-5 | 10% |
| 3-Ph—Ph1—Ph-3 | 7% | 3-Cy—Ph—Ph—Cy-3 | 4% | 5-Cy—Ph—Ph1—Ph-2 | 2% |
| 3-Ph—Ph3—CFFO—Ph3—F | 2% | 3-Ph—Ph1—Ph3—F | 9% | 3-Ph—Ph3—CFFO—Ph3—F | 7% |
| 3-Cy—Cy—Ph1—Ph3—F | 2% | 2-Ph—Ph3—Ph3—F | 7% | 3-Cy—Cy—Ph1—CFFO—Ph3—F | 6% |
| 3-Cy—Ph—Ph3—Ph1—OCFFF | 7% | 3-Ph—Ph3—CFFO—Ph3—F | 4% | | |
| | | 3-Cy—Ph—Cl | 3% | | |
| | | 3-Cy—Cy—Ph1—Ph3—F | 3% | | |

Liquid crystal compositions LCM-14 to LCM-16 were prepared by adding 0.03% of a compound represented by formula (I-3-1) to 99.97% of the liquid crystal compositions LC-14 to LC-16, respectively. The physical properties of LCM-14 to LCM-16 were substantially the same as those of LC-14 to LC-16.

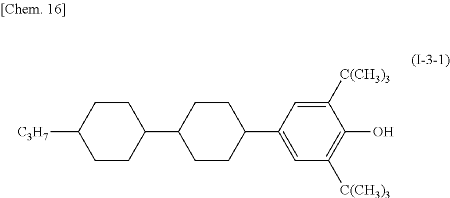

The initial VHRs of the liquid crystal compositions LCM-14 to LCM-16 were substantially the same as the VHRs after they were left to stand at a high temperature of 150° C. for 1 hour. An IPS mode liquid crystal display device was produced using each of the liquid crystal compositions LCM-14 to LCM-16, and the image sticking and the drop mark were evaluated. The evaluation results were excellent as shown below.

TABLE 16

| | LCM-14 | LCM-15 | LCM-16 |
|---|---|---|---|
| Initial VHR (%) | 98.8 | 98.7 | 98.9 |
| VHR (%) after 150° C. for 1 hour | 98.5 | 98.3 | 98.6 |
| Drop mark evaluation | A | A | A |
| Image sticking evaluation | A | A | A |

### Example 17 to Example 19

Liquid crystal compositions LCM-17 to LCM-19 were prepared by adding 0.03% of a compound represented by formula (I-2-1) to 99.97% of the liquid crystal compositions LC-14 to LC-16, respectively. The physical properties of LCM-17 to LCM-19 were substantially the same as those of LC-14 to LC-16.

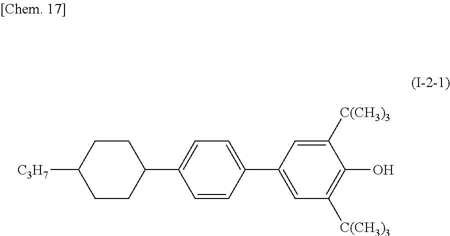

The initial VHRs of the liquid crystal compositions LCM-17 to LCM-19 were substantially the same as the VHRs after they were left to stand at a high temperature of 150° C. for 1 hour. A VA mode liquid crystal display device was produced using each of the liquid crystal compositions LCM-17 to LCM-19, and the image sticking and the drop mark were evaluated. The evaluation results were excellent as shown below.

TABLE 17

| | LCM-17 | LCM-18 | LCM-19 |
|---|---|---|---|
| Initial VHR (%) | 98.8 | 98.8 | 98.8 |
| VHR (%) after 150° C. for 1 hour | 98.4 | 98.2 | 98.4 |
| Drop mark evaluation | A | A | A |
| Image sticking evaluation | A | A | A |

### Example 20

A polymerizable liquid crystal composition CLCM-1 was prepared by adding 0.3% of a polymerizable compound represented by formula (IV-b) to 99.7% of the nematic liquid crystal composition LCM-1 shown in Example 1 and by uniformly dissolving the polymerizable compound in the nematic liquid crystal composition LCM-1.

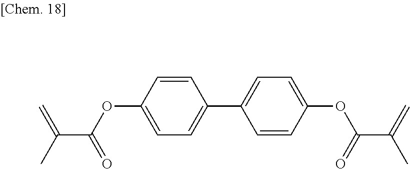 [SMILES: C=C(C)C(=O)Oc1ccc(-c2ccc(OC(=O)C(=C)C)cc2)cc1]

The physical properties of CLCM-1 were substantially the same as those of the nematic liquid crystal composition shown in Example 1. CLCM-2 was injected, by a vacuum injection method, into an ITO cell which had a cell gap of 3.5 μm and to which a polyimide alignment film that induces homogeneous alignment was applied. The liquid crystal cell was irradiated with ultraviolet rays using a high-pressure mercury lamp through a filter that cuts off ultraviolet rays with a wavelength of 320 nm or less while a rectangular wave at a frequency of 1 kHz was applied to the cell. The irradiation was performed for 600 seconds so that the irradiation intensity on the surface of the cell was 10 mW/cm². Thus, a liquid crystal display device with a horizontal alignment property was obtained in which the polymerizable compound in the polymerizable liquid crystal composition was polymerized. It was confirmed that the polymerization of the polymerizable compound generated anchoring strength for the liquid crystal compound.

1-9. (canceled)

10. A nematic liquid crystal composition comprising, as a first component, one or more compounds selected from the group consisting of compounds represented by general formula (I-1) to general formula (I-3), 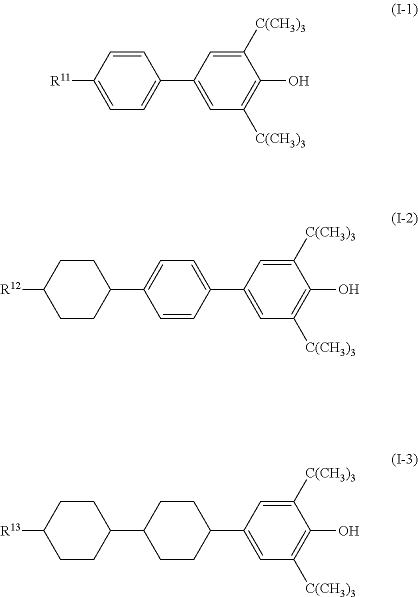
(in the formulae, R¹¹ to R¹³ represent an alkyl group or alkoxy group having 1 to 22 carbon atoms);
as a second component, one or more compounds selected from the group consisting of compounds represented by general formula (II-a) to general formula (II-e), 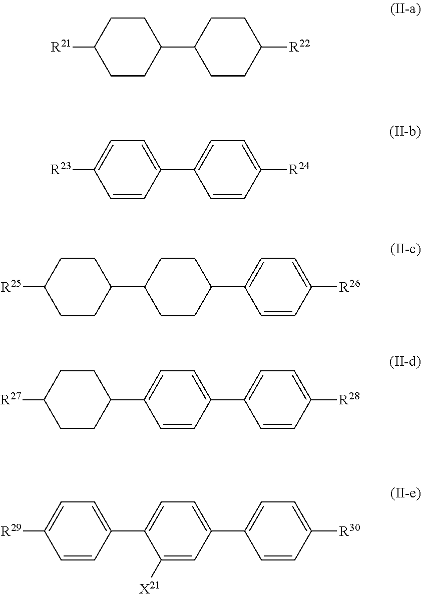
(in the formulae, R²¹ to R³⁰ each independently represent an alkyl group having 1 to 10 carbon atoms or an alkenyl group having 2 to 10 carbon atoms, and X²¹ represents a hydrogen atom or a fluorine atom); and
as a third component, one or more compounds represented by general formula (III), 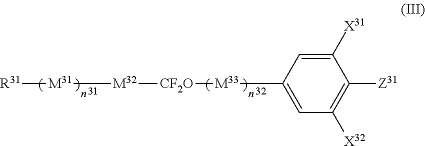
(in the formula, R³¹ represents an alkyl group or alkoxy group having 1 to 10 carbon atoms or an alkenyl group or alkenyloxy group having 2 to 10 carbon atoms; M³¹ to M³³ each independently represent a trans-1,4-cyclohexylene group or a 1,4-phenylene group, one or two —CH₂— in the trans-1,4-cyclohexylene group may be substituted with —O— as long as oxygen atoms are not directly adjacent to each other, and one or two hydrogen atoms in the phenylene group may be substituted with fluorine atoms; X³¹ and X³² each independently represent a hydrogen atom or a fluorine atom; Z³¹ represents a fluorine atom, a trifluoromethoxy group, or a trifluoromethyl group; n³¹ and n³² each independently represent 0, 1, or 2; n³¹+n³² represents 0, 1, or 2; and when a plurality of M³¹ and M³³ are present, the plurality of M³¹ may be the same or different and the plurality of M³³ may be the same or different),
wherein a dielectric anisotropy (Δ∈) at 25° C. is +3.5 or more.

11. The nematic liquid crystal composition according to claim 10, wherein the general formula (III) includes general formula (III-a) to general formula (III-e), 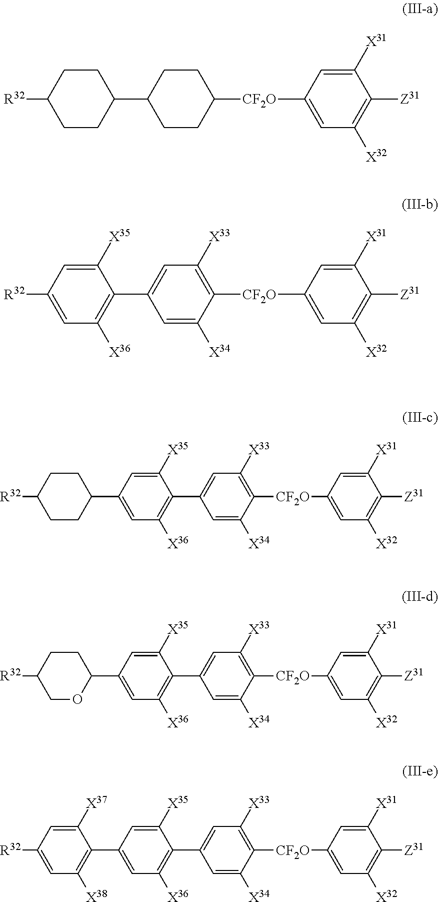
(in the formulae, R³² represents an alkyl group or alkoxy group having 1 to 10 carbon atoms or an alkenyl group or alkenyloxy group having 2 to 10 carbon atoms; X³¹ to X³⁸ each independently represent a hydrogen atom or a fluorine atom; and Z³¹ represents a fluorine atom, a trifluoromethoxy group, or a trifluoromethyl group).

12. The nematic liquid crystal composition according to claim 10, further comprising one or more compounds selected from the group consisting of compounds represented by general formula (IV-a) to general formula (IV-f), 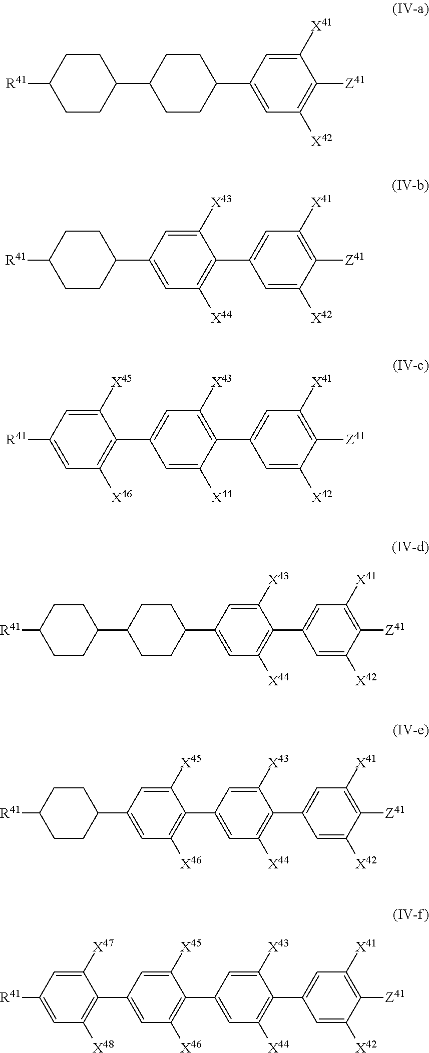
(in the formulae, R⁴¹ represents an alkyl group or alkoxy group having 1 to 10 carbon atoms or an alkenyl group or alkenyloxy group having 2 to 10 carbon atoms; X⁴¹ to X⁴⁸ each independently represent a hydrogen atom or a fluorine atom; and Z⁴¹ represents a fluorine atom, a trifluoromethoxy group, or a trifluoromethyl group).

13. The nematic liquid crystal composition according to claim 10, wherein a content of the compounds selected from the group consisting of the compounds represented by the general formula (I-1) to the general formula (I-3) is 0.001 mass % to 1 mass %, and a content of compounds represented by general formula (II) is 10 mass % to 70 mass %.

14. The nematic liquid crystal composition according to claim 10 comprising a polymerizable compound represented by general formula (V), 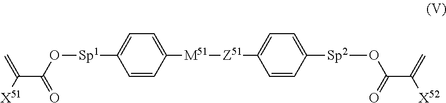
(in the formula, X⁵¹ and X⁵² each independently represent a hydrogen atom or a methyl group;
Sp¹ and Sp² each independently represent a single bond, an alkylene group having 1 to 8 carbon atoms, or —O—(CH₂)ₛ—
(in the formula, s represents an integer of 2 to 7, and an oxygen atom bonds to an aromatic ring);
Z⁵¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond; and
M⁵¹ represents a 1,4-phenylene group, a trans-1,4-cyclohexylene group, or a single bond, and, in all the 1,4-phenylene groups in the formula, any of hydrogen atoms may be substituted with fluorine atoms).

15. An active matrix driving liquid crystal display device using the liquid crystal composition according to claim 10.

16. A liquid crystal display device for an IPS mode, an FFS mode, or a VA-IPS mode, the liquid crystal display device using the liquid crystal composition according to claim 10.

17. A polymer stabilized liquid crystal display device using the nematic liquid crystal composition containing the polymerizable compound according to claim 14, wherein the liquid crystal display device is produced by polymerizing the polymerizable compound contained in the liquid crystal composition while a voltage is applied or no voltage is applied.
